(19) United States
(12) Patent Application Publication
(10) Pub. No.: US 2007/0119714 A1
(43) Pub. Date: May 31, 2007

(54) Methods and devices for analysing a deformable object

(75) Inventors: Thomas Schnelle, Berlin (DE); Torsten Muller, Berlin (DE); Andre Homke, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Evotec Technologies GmbH, Dusseldorf (DE)

(21) Appl. No.: 10/595,771

(22) PCT Filed: Nov. 10, 2004
(86) PCT No.: PCT/EP04/12741

§ 371 Date: Jun. 29, 2006

(30) Foreign Application Priority Data
Nov. 10, 2003 (DE) 103 52 416.9

(51) Int. Cl. B03C 5/02

(52) U.S. Cl. 204/547; 204/643

(57) ABSTRACT

Methods are described for analyzing at least one deformable object (O) in a suspension fluid, including the following steps: generation of an electric positioning field and positioning of the object (O) in a potential minimum of the positioning field, generation of an electric deformation field in such a way that a deformation force is exerted on the object (O), and detection of at least one property selected from the group including the dielectric, geometric and optical properties of the object (O), wherein the positioning field is generated in a compartment (12) of a fluidic microsystem (10) and the positioning of the object (O) takes place in a contactless manner in a freely suspended state. Measuring apparatuses for carrying out this method are also described.

The invention relates to methods for analyzing a deformable object suspended in a fluid, in particular for analyzing deformation properties of biological particles, such as of biological cells for example, said methods having the features of the preamble of claim 1. The invention also relates to devices for implementing such methods and to applications of high-frequency field cages in fluidic Microsystems.

It is known that damaged, transformed or degenerated biological cells often have mechanical properties which differ from healthy cells, wherein they are usually softer than healthy cells (see B. Alberts et al. in “Lehrbuch der molekularen Zellbiologie [Textbook of Molecular Cell Biology]”, Wiley VCH, Weinheim, 1998; and J. M. Vasiliev et al. in “BBA” vol. 780, 1985, pages 21-65 “Spreading of non-transformed and transformed cells”). Moreover, different cell types, such as white and red blood cells for example, differ in terms of their deformability (see R. Glaser in “Biophysik”, Spektrum Akademischer Verlag, Heidelberg, 1996). It has furthermore been found that cancer cells can be 2 to 10 times softer than healthy cells and deform to a much greater extent than healthy cells under the effect of forces (see J. Guck et al. in “Biophysical Journal”, vol. 81, 2001, pages 767-784). It is known that the cytoskeleton and thus the viscoelastic properties of cells can be altered by adding certain agents, e.g. cytochalasin or colchicine (see B. Alberts et al.). B. Alberts et al. also describe that the cytoskeleton is altered during cell ontogenesis/differentiation and during the cell cycle.

An example of damaged biological cells having mechanical properties which are altered as a result of the damage is red corpuscles damaged by parasite infection in malaria (see F. K. Glenister et al. in “Contribution of parasite proteins to altered mechanical properties of malaria-infected red blood cells”, BLOOD, vol. 99, No. 3, 2002, pages 1060 to 1063).

In order to distinguish between cancer cells and healthy cells, J. Guck et al. and U.S. Pat. No. 6,067,859 propose an optical micromanipulator which acts as a so-called optical stretcher (or laser stretcher). The optical stretcher uses two opposing and barely focused laser beams in order to trap cells, which are suspended in a fluid, in the flux at a low light output (10 -100 mW). When the light output is increased (100 mW -1.5 W), the cells are distorted (deformed) to different degrees depending on the cell type. Healthy cells are barely altered, whereas tumour cells deform considerably.

The use of the optical stretcher to detect cancer cells has a number of disadvantages. One main disadvantage is the fact that the optical stretcher can function reliably only with individual cells, there being no possibility for selecting individual cells from the suspension fluid. A number of cells trapped between the laser beams enter into interaction with one another, thereby affecting the deformation to be analyzed. In order to prevent this problem, the procedure must be carried out with extremely dilute samples. The sample throughput is restricted as a result. A further disadvantage is the fact that the detection of the deformation cannot reliably be automated. Finally, another disadvantage of the laser stretcher is the fact that the trap area has only a small size of, for example, 5 μm on account of the small diameter of the light guide for introducing the laser beams.

In the publication “Reversible Electropermeabilization of mammalian cells by high-intensity, ultra-short pulses of sub-microsecond duration” by K. J. Muller et al. (“J. Membrane Biol.”, vol. 184, 2001, pages 161-170) it is described that cells suspended in a fluid can be deformed in electric DC or AC voltage fields (E). Depending on the electrical conductivities σ of the suspension fluid (index I) and of the cell cytosol (index c), both elongating and compressive pressures P_{D} can be exerted (see FIG. 6). For high-frequency fields, the following is obtained for the pressure (stress) P_{D} (∈₀: absolute dielectric constant, ∈₁: relative dielectric constant of the suspension fluid, Θ: angle between the electric field and the direction of action of the pressure in question):

$${P}_{D} = \frac{9}{2} {ɛ}_{0} {ɛ}_{1} {E}^{2} {cos}^{2} [ Θ ] \frac{{σ}_{c}^{2} - {σ}_{l}^{2}}{{( {σ}_{c} + 2 {σ}_{l} )}^{2}} \qquad ( 1 )$$

The deformation of cells as described by K. J. Müller et al. serves to influence the permeability of the cell membrane during the so-called electropermeabilization. This deformation technique is unsuitable for the abovementioned detection of healthy or diseased cells, for the following reason. Depending on the mechanical and dielectric properties of the cells, field strengths of a few tens of kV/m to the MV/m range are required for deformation purposes. On account of the high field strengths, the procedure is carried out only in solutions of low conductivity, in order to prevent ohmic losses. In this process, the cells are additionally drawn towards the electrodes via positive dielectrophoresis in order to generate the DC or AC voltage fields, so that interactions occur between the cells and the electrodes which make it difficult to observe the deformation in a reproducible and quantitative manner. Due to the fact that the cell makes contact with the electrodes, the vitality of the cell is affected and it often cannot detach from the electrodes or cannot detach therefrom without being destroyed.

The application of high-frequency electric fields for analyzing the viscoelastic properties of erythrocytes is described by H. Engelhardt et al. in: “Nature”, vol. 307, 1984, pages 378-380, “Viscoelastic properties of erythrocyte membranes in high-frequency electric fields”. Sharp-edged electrodes are arranged at a spacing of 50 μm in a cuvette. When the electrodes are acted upon by a high-frequency electric voltage, individual erythrocytes or a number of erythrocytes arrange themselves between the electrodes. The erythrocytes are drawn towards the electrodes. As a result of a temporary increase in field strength, a deformation occurs which can be optically observed and quantitatively evaluated. The technique described by H. Engelhardt has a number of disadvantages. One significant problem is the fact that, as in the above-described technique of K. J. Müller et al., the erythrocytes make contact with the electrodes. As a result, the observation of the deformation is falsified. Moreover, the erythrocytes cannot be deformed in a defined manner in different directions. Another problem is that, under the test conditions proposed by H. Engelhardt et al., the procedure must be carried out with an extremely low conductivity of the buffer solution which surrounds the erythrocytes. The conductivity of the buffer solution lies in the range from 1 mS/m to 10 mS/m. However, these conductivities are considerably less than the conductivities of physiological solutions, so that the erythrocytes being analyzed are exposed to additional stress or may be destroyed.

Another disadvantage of the measurement proposed by H. Engelhardt et al. is the fact that only an integral light measurement is provided. It is not possible for topographic deformation images to be recorded using the conventional technique. Finally, the technique described by H. Engelhardt et al. cannot be carried out in a flow-through system and is unsuitable for automation.

It is furthermore known to trap and hold individual cells under the effect of high-frequency electric fields in field cages by means of negative dielectrophoresis. The application of high-frequency field cages was previously aimed at the gentlest possible manipulation of the cells, where one-sided force effects or deformations of the cells were specifically undesired. By way of example, H. Wissel et al. describe in “American Journal of Physiology Lung Cell Mol. Physiol.” (vol. 281, 2001, L345-L360 “Endocytosed SP-A and surfactant lipids are sorted to different organelles in rat type II pneumocytes”) that cells can be held in a gentle manner even at high field strengths, since on the one hand they are located in a field minimum (zero field) and on the other hand use is made of microelectrodes which minimize the heating effect.

T. Schnelle et al. describe in “J. Electrostat.” (vol. 50, 2000, pages 17-29, “Trapping in ac octode field cages”) different phase activations of dielectric high-frequency field cages. By virtue of suitable activation, objects can be held in a stable manner or released in a targeted manner from the field cage in one direction, or conditions can be found under which a number of objects in the cage can be brought into contact with one another.

The objective of the invention is to provide improved methods for analyzing deformation properties of objects, in particular of biological cells, by means of which the disadvantages of the conventional methods are overcome and which in particular allow the characterization of deformation properties with increased accuracy and reproducibility. Methods according to the invention are moreover intended to allow quantitative characterization of the deformation properties and are intended be able to be automated with a reduced complexity in terms of device. Another objective of the invention is to provide improved devices for analyzing deformation properties of objects, in particular for implementing the methods according to the invention.

These objectives are solved by means of methods and devices having the features of claims 1 and 25. Advantageous embodiments and uses of the invention can be found in the dependent claims.

In method terms, the invention is based on the general technical teaching that, in order to analyze an object suspended in a fluid once said object has been positioned in a potential minimum of a high-frequency electric positioning field in an analysis area of a fluidic microsystem, a deformation force is exerted on the object by means of a deformation field and a reaction of the object to the deformation force is determined by detecting at least one property selected from the group comprising the electric, geometric and optical properties of the object. Advantageously, the application of the high-frequency electric positioning field permits a contactless, dielectric positioning of individual objects with high stability and positioning accuracy. The contactless positioning comprises a holding of individual objects, such as individual biological cells, for example, in a freely suspended state, that is to say freely floating in the suspension fluid or a treatment fluid without any direct mechanical contact with (without directly touching) components of the fluidic microsystem. During the positioning and deformation, the object to be analyzed is in free solution, that is to say it is surrounded by the fluid on all sides, at a distance from all adjacent wall surfaces or electrodes of the microsystem. The stability of the positioning makes it possible for a detector to be adjusted precisely onto the object and to be set up to detect the desired properties.

According to one preferred embodiment of the method according to the invention, the deformation field acts on the basis of negative dielectrophoresis. The combination proposed for the first time by the present invention of holding by means of negative dielectrophoresis together with the effect of the deformation field has the advantage of allowing a particularly gentle analysis of biological objects in fluidic Microsystems, as are already available for the manipulation, treatment, sorting and analysis of biological cells for example.

Preferably, a trapping field is generated by negative dielectrophoresis and, in an alternating manner or at the same time, a deformation field is generated using positive or negative dielectrophoresis, wherein contact of the objects with the electrodes can be prevented by virtue of this combination of trapping field and deformation field.

The holding of the objects by negative dielectrophoresis has particular advantages when analyzing biological objects. The conductivity of the surrounding suspension fluid or treatment fluid can be considerably increased compared to the technique described by H. Engelhardt, in particular into the range of physiological conditions. The conductivity can, for example, be set to be greater than 0.3 S/m and in particular to correspond to the physiological value of 1.5 S/m. Particularly during measurement on biological cells in which the conductivity inside the cell is lower than in the external medium, negative dielectrophoresis advantageously occurs in the entire frequency range of interest, in particular from above 1 kHz into the GHz range. Compared to conventional techniques, a larger frequency range is available for the deformation field, where the deformation field can be generated for negative or positive dielectrophoretic conditions and different deformation effects can be set at different frequencies. Another important advantage of the use of a suspension fluid or treatment fluid with an increased external conductivity consists in the reduction in ohmic heating effects, e.g. by up to a factor of 5, so that the cell physiology is barely affected during the measurement.

According to one alternative variant, the deformation field acts on the basis of positive dielectrophoresis, and this may be advantageous for certain objects for contactless holding purposes.

By means of the method according to the invention and the device according to the invention, contact with the electrodes is advantageously generally avoided. As a result, particularly when treating cells, mechanical damage to the cells is avoided. By virtue of a suitable temporal and geometric field configuration, deformation can take place both in homogeneous and in inhomogeneous electric fields, depending on the parallel or antiparallel polarization in the external electric field.

Which of the electric, geometric and/or optical properties of the object is detected depends on the specific application of the invention. For example, by virtue of an impedance measurement in the analysis area, it is possible to ascertain whether and at which rate the object is deformed and optionally relaxes in the undeformed state. This variant may be advantageous for the operation of automated microsystems without optical process monitoring. A detection of the geometric properties of the object accordingly means that the external shape of the object is detected for example by means of a camera during the deformation and/or relaxation and then evaluated. The detection of optical properties means the detection of the interaction of the object with light, such as a fluorescence measurement or a scattered light measurement for example. When the analysis according to the invention is carried out for example on biological cells, which react to mechanical stimuli by a change in the membrane structure and may accordingly activate fluorescence markers, the optical detection comprises a fluorescence measurement during the deformation and/or relaxation.

Further important advantages of the methods according to the invention consist in that they permit a reproducible, quantitative evaluation of the detected properties in order to determine elastic properties of the object, such as the viscoelastic properties of biological cells for example. The method can be fully automated. The detection of properties which are characteristic of the deformation or relaxation may take place in real time or at a later point in time via stored data (for example a video recording) using image evaluation algorithms which are known per se. Static or dynamic elastic properties of the objects to be analyzed can be determined.

The method according to the invention advantageously has a high degree of flexibility in terms of the time of the deformation measurement. According to preferred embodiments of the invention, the detection can be carried out once or a number of times at points in time, which are selected from the entire time period during and after the deformation of the object. Accordingly, the detection may comprise a determination of deformation properties or, in the case of brief exertion of the deformation forces, relaxation properties of the object. Advantages with regard to an increased information content of the detection may be obtained if a time dependence of the respectively measured electric, geometric and/or optical parameters is determined.

Particular advantages especially when analyzing biological samples can be obtained if the positioning field is generated as a high-frequency field cage by means of a cage electrode arrangement, since experience has already been obtained with the configuration and activation of high-frequency field cages known per se.

According to one variant of the invention, the high-frequency field cage is operated as a field cage, which is closed on all sides and has an essentially punctiform potential minimum which is stationary within the microsystem. Advantageously, the deformation and detection can be carried out on the resting object. According to one alternative variant of the invention, the high-frequency field cage is operated as an open field cage with a linear potential minimum, which extends in the longitudinal direction of a channel in the fluidic microsystem. The object moves with the suspension fluid through the cage electrode arrangement, wherein the field cage ensures only a positioning of the object on a certain trajectory through the channel. The deformation and detection can be carried out dynamically on the moving object, so that the invention can also be carried out during continuous operation of high throughput systems.

Advantageously, the technical complexity when implementing the invention can be reduced if the cage electrode arrangement provided for forming the positioning field is also used to generate the deformation field. By switching from a trapping or positioning mode to a stretching or deformation mode, dielectric and/or optical properties and additionally the desired mechanical-elastic properties of the object can be analyzed in a manner known per se. This variant is particularly advantageous for screening tasks in which the mechanical-elastic properties of the object are to be placed in relation to other measurement parameters. Alternatively, a separate deformation electrode arrangement can be used to generate the deformation field, wherein advantages may be obtained in respect of controlling the positioning and deformation fields.

If, according to one preferred embodiment of the invention, the deformation field is set for a duration of 1 ms to 500 ms, advantages can be obtained with regard to a relatively low mechanical, low electrical and low thermal stress of the object. It is particularly advantageous if the generation of the deformation field takes place in a pulsed manner, since in this case the time response of the relaxation of the object deformation can be detected with increased accuracy.

If a treatment fluid is introduced into the analysis area before the generation of the deformation field, a temporary solution exchange may advantageously take place, for example in order to analyze the deformation behavior of the object in different media or to treat the object with a certain treatment fluid between analyses with different deformation directions. In this case, the object is preferably positioned at a channel mouth or channel intersection in the fluidic microsystem, to which the respective treatment fluid is fed.

According to another preferred embodiment of the invention, a multiple measurement takes place on a certain object, such as a biological cell to be analyzed for example. To this end, the steps of generation of the deformation field and detection are carried out a number of times one after the other. The multiple detection may for example be aimed at repeating the deformation under identical process conditions in order to increase the accuracy of the measurement. As an alternative or in addition, the process conditions, such as for example the exerted forces, the field strengths, phases and/or frequencies of the high-frequency electric fields, the duration of the action of force or the addition of the treatment fluid, can be varied in order to obtain additional information about the object. Advantageously, a control loop may in particular be formed, in which the positioning field and/or the deformation field is adjusted as a function of the result of the preceding detection. Furthermore, during successive analyses, the deformation field can be adjusted and/or the object can be rotated in such a way that the object is deformed in different directions. This variant of the invention may have advantages for analyzing objects with anisotropic elastic properties.

If the multiple measurement takes place over a relatively long period of time, it is advantageously possible to analyze plastic deformations or the deformation as a function of the exerted force. To this end, the duration of the multiple measurement is preferably at least one second.

When implementing the invention in practice, particularly when analyzing biological cells, it is preferred to determine elastic properties of the object from the detected dielectric, geometric and/or optical properties. As the deformation property, it is possible for example for one or more of the following variables to be detected as integral or structure-selective parameters: modulus of elasticity, shear modulus, viscosity, spring constant, stiffness constant and relaxation time. Furthermore, adaptation may take place on the basis of models known per se, as described for example by H. Engelhardt et al. (see above). The invention is not restricted to the measurement of elastic properties. It is also possible for plastic deformation properties or intermediate forms between elastic and plastic behaviors to be determined.

Further advantages when analyzing samples containing a plurality of objects, of which one or more objects are to be analyzed individually, are obtained when the method according to the invention is combined with a dielectric cell sorter, which is designed to line up and optionally sort the objects. If, prior to the positioning step, a certain object is selected from the sample, which has been subjected to a dielectric lining-up operation, the selectivity of the deformation analysis according to the invention can be increased.

The method according to the invention can generally be carried out with any flexible, in particular elastically or plastically deformable object, which is smaller than the respective analysis area. For the preferred use in fluidic Microsystems, objects to be analyzed typically have sizes in the range from 1 μm to 50 μm. The object may be formed with a regular or irregular shape and may in particular be spherical. The object may be a synthetic object made from a deformable, compact or hollow material. According to the invention, membrane vesicles which are filled with a fluid may be analyzed for example in order to analyze the structure of the membrane shell. Preferred uses of the invention are obtained when the object to be analyzed comprises at least one biological cell, cell group, cell constituent or such an object in association with a synthetic particle. The object to be analyzed may also be porous and the objects themselves may be cells, cell pairs, cell aggregates/cell groups or cell constituents. It is furthermore possible that synthetic particles, for example a number of beads, may also aggregate.

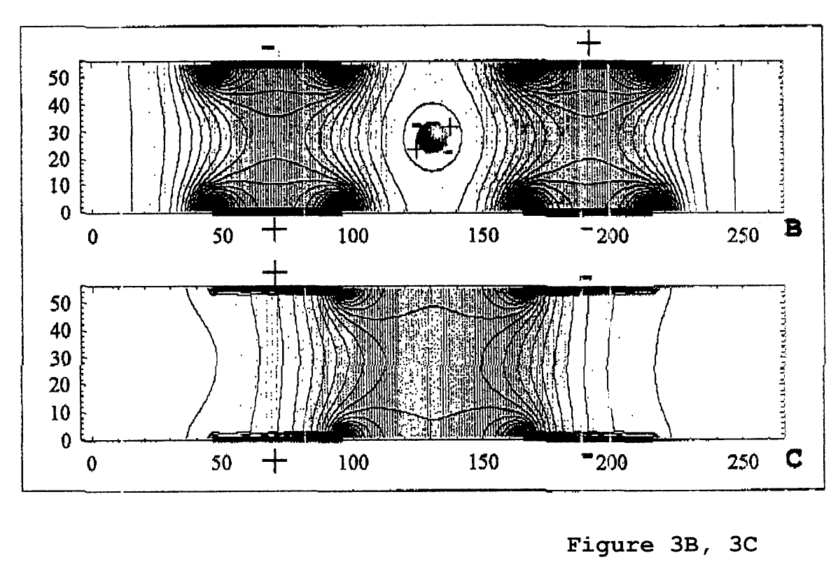

It is also possible, by virtue of standard control of a dielectrophoretic field cage, to achieve a symmetrical deformation of objects, which are not small in relation to the cage (size ratio for example around ½) and can be deformed relatively easily. Cells which are trapped centrally in a cage and which are small in relation to the electrode dimensions of the cage (for example ⅛) cannot normally be deformed. The cell does not undergo any dipole polarization in the trapping spot. In order nevertheless to generate a deformation by multiple poles, it is preferred that the trapping field is not closed, as shown for example in FIGS. 3A and 3B.

The preferred application of the invention in biotechnology and pharmacy is based on the concept of trapping individual cells in dielectric field cages and of briefly altering the field at the electrodes in such a way that sufficiently high deformation forces are generated. The electric field can then be returned to the trapping mode and the relaxation of the cell deformation can be observed in the range of low field strengths. Alternatively, the field can also be completely switched off for a short time between the modes. This process can advantageously be repeated a number of times on a cell. According to one preferred variant of the invention, a distinction is made between normal and altered cells or between normal cells having different physiological properties as a function of the detected dielectric, geometric and/or optical properties, for example during their cell cycle. Furthermore, the method according to the invention can be used to distinguish between normal differentiated cells and stem cells. The method according to the invention can in particular be used to identify and sort stem cells from a plurality of cells. Additional information regarding the analyzed cells can be obtained if the dielectric, geometric and/or optical properties of the cell are detected as a function of the frequency and/or voltage of the positioning field and/or of the deformation field. Furthermore, dependencies on the ambient temperature, the material composition, the surrounding fluid and/or the duration of individual deformations or the duration of multiple measurements can also be carried out.

If, according to the invention, a measurement takes place of cell pairs or cell aggregates, which are optionally brought together or joined only in the positioning field, advantages are obtained over the laser stretcher, by means of which only individual particles can be deformed.

In device terms, the abovementioned object of the invention is achieved by means of a measuring apparatus for analyzing at least one object, which contains a fluidic microsystem, which has an analysis area containing at least one electrode arrangement, a detector device for the electric and/or optical measurement of object properties, and a field forming device comprising at least one high-frequency generator and a switching device, by means of which it is possible to switch between the trapping mode in which a high-frequency positioning field is generated in the analysis area by means of the at least one electrode arrangement and the deformation mode in which a deformation field is generated in the analysis area by means of the at least one electrode arrangement.

If the detector device comprises a microscope with a camera, advantages can be obtained with regard to the accuracy of the detection on microscopically small objects, the diameter of which is typically less than 25 μm.

According to one preferred embodiment of the invention, the measuring apparatus is equipped with a control device, which is connected to the detector device and the switching device. This connection advantageously permits the formation of a control loop in which parameters of the positioning field and/or the deformation field and/or the suspension fluid can be adjusted or changed as a function of the result of a detection.

The fluidic microsystem of the measuring apparatus is preferably equipped with a fluidic device, by means of which the suspension fluid and/or an additional treatment fluid can be moved through the analysis area, and which is likewise connected to the control device.

Another, independent subject matter of the invention is the application of a fluidic microsystem with a high-frequency field cage for analyzing deformation and/or relaxation properties of biological cells, and in particular for separating or sorting healthy cells and diseased cells, for example cancer cells, or sorting stem cells from a cell sample.

The invention has the following further advantages. For the first time, an analysis method is provided by means of which the deformation and/or relaxation of biological cells can be detected in a way that can be fully automated. The inventors have found that, in the case of cells which are held dielectrically in high-frequency field cages by means of high-frequency electric fields, high deformation forces can be exerted in such a way that the deformation fields have to be generated only for short periods of time and in a locally restricted manner. The stress on the cells is thus reduced. Furthermore, undesirable heating of the electrode arrangement in the analysis area is avoided or considerably reduced.

The deformation of particles, in particular cells, can be assisted or achieved if the cells are occupied by beads or metal balls (Au). These beads or metal balls exhibit positive dielectrophoresis at a suitable trapping frequency, and can thus deform the particles or cells. Moreover, it is also possible for cells to phagocyte beads or metal balls.

Another advantageous possibility for deforming cells or particles is to use magnetic beads by means of which the cells are occupied or which are phagocyted by the cells, in order to achieve a deformation of the magnetic beads and thus of the cells by means of an arrangement of switchable magnetic elements, for example electromagnets arranged outside the channel.

Another advantageous possibility for achieving a deformation of a cell or of a particle is to excite the object to oscillate at a resonant frequency, by rapidly switching the deformation field on and off. As a result, a repeated deformation at the resonant frequency is obtained, wherein a measurement of the damping of the oscillation allows conclusions to be drawn about mechanical properties of the cell.

The method according to the invention or the device according to the invention can also advantageously be used for pair separation. Pair separation will be understood to mean the separation of two or in some circumstances even a number of particles that are attached to one another. If such a pair is trapped in an electrode arrangement according to the invention and then separated by switching to the stretching mode, a separation of the objects into different flow paths can be achieved as a function of the forces exerted by the dielectrophoresis. By varying the frequencies and/or deformation voltage and/or deformation time, further characterization of the bond between objects is also made possible.

Further details and advantages of the invention will become clear from the description of the appended drawings, in which:

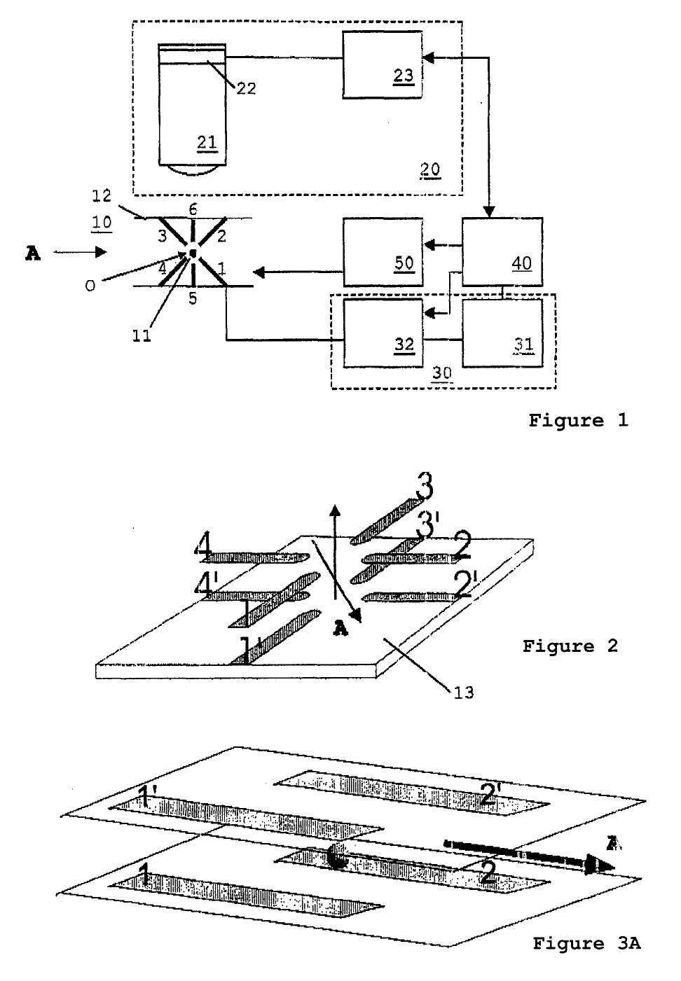

FIG. 1 shows a schematic representation of one embodiment of a measuring apparatus according to the invention,

FIGS. 2, 3 show schematic, enlarged illustrations of electrode arrangements used according to the invention,

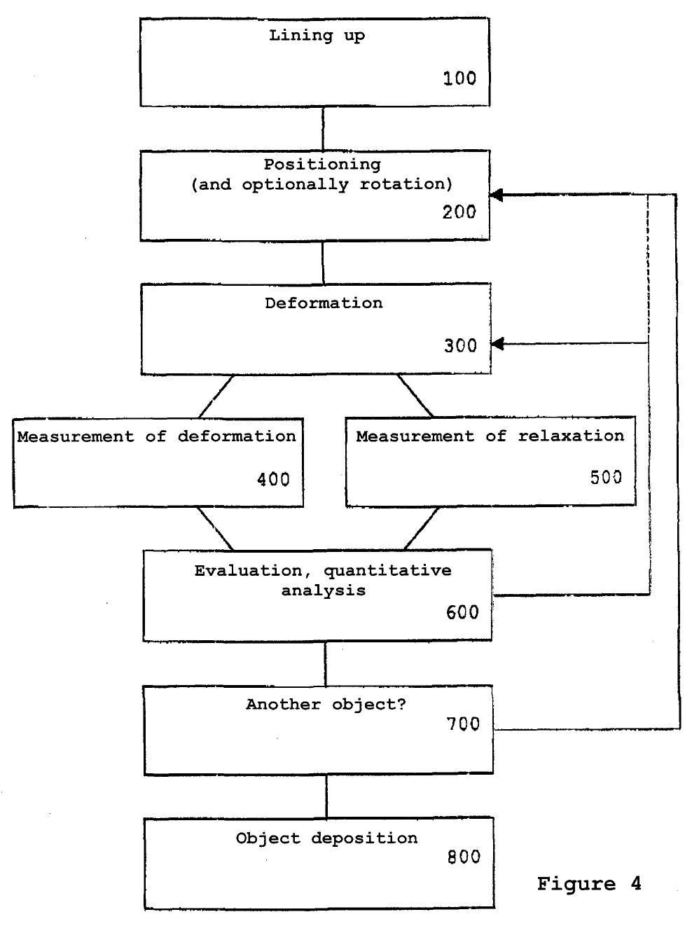

FIG. 4 shows a flowchart to illustrate one embodiment of a method according to the invention,

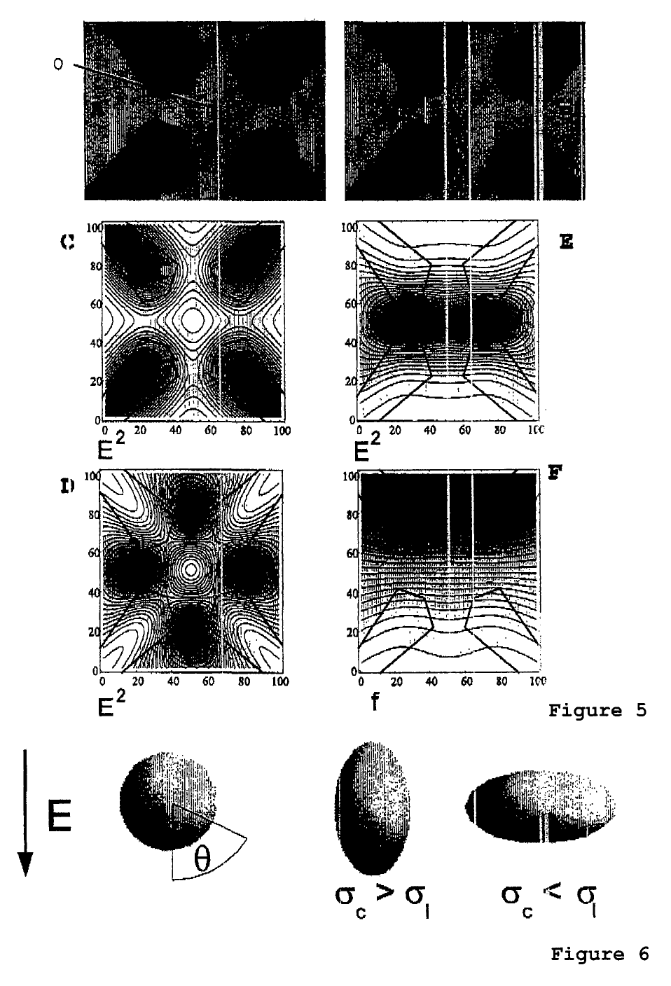

FIG. 5 shows measurement and simulation results to illustrate the deformation of cells according to the invention,

FIG. 6 shows a schematic illustration of the object deformation in an external electric field, and

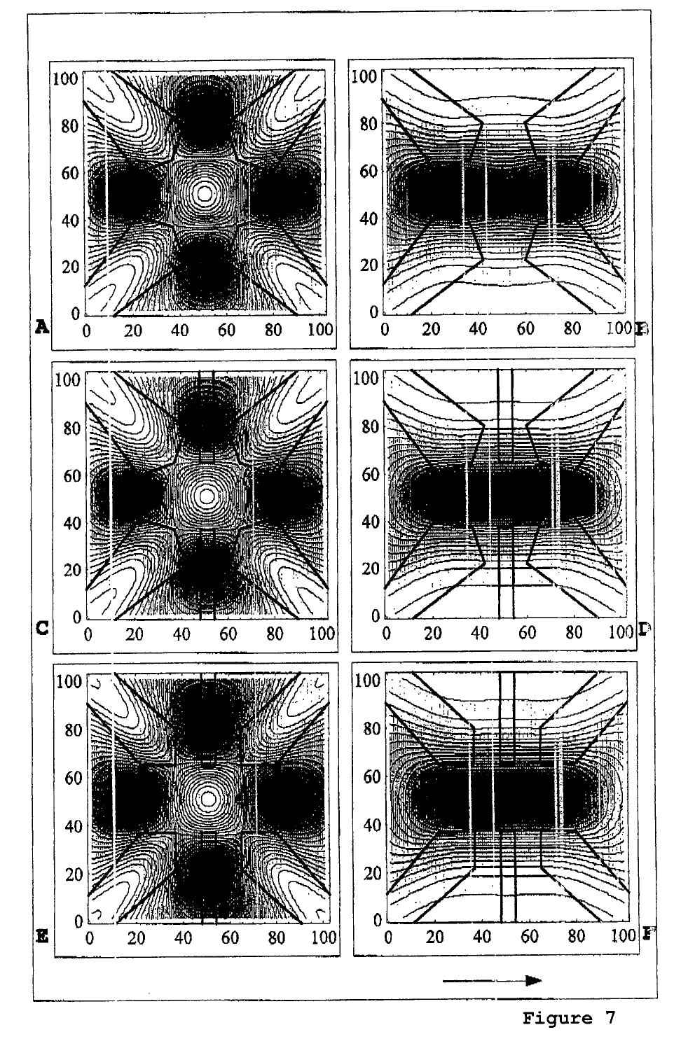

FIG. 7 shows schematic, enlarged illustrations of electrode arrangements used according to the invention.

The invention will be described below by way of example with reference to the analysis of biological cells in a fluidic microsystem. It is pointed out that the implementation of the invention is not restricted to the analysis of biological cells, but rather is accordingly possible in particular with the abovementioned types of objects. Fluidic Microsystems with electrode arrangements for the dielectric manipulation of suspended particles are known per se, and therefore only the details necessary for implementing the method according to the invention will be discussed here.

FIG. 1 shows one embodiment of the measuring apparatus according to the invention comprising the fluidic microsystem 10, the detector device 20 and the field forming device 30. The fluidic microsystem 10 is shown only in part with an electrode arrangement of cage electrodes 1-4 and optionally provided deformation or impedance measuring electrodes 5, 6. The electrodes 1-6 are microelectrodes known per se, which are arranged on bottom, side and/or top walls of a compartment, e.g. a channel 12 of the fluidic microsystem. The channel 12 is flowed through by a suspension fluid in arrow direction A. The analysis area 11 is formed between the ends of the electrodes (tips of the electrodes) of the electrode arrangement 1-6, in which analysis area the abovementioned positioning and deformation of the object O to be analyzed are carried out. The analysis area 11 may be formed at a point where the channel 12 intersects another channel (not shown) of the microsystem, in order optionally to expose the object O in the held state to a treatment fluid, which is fed through the other channel.

The detector device 20 comprises a microscope 21, a camera 22 and an image data memory 23, which cooperate in a known manner. The microscope 21 is for example an IX70 (manufacturer: Olympus) with a CCD camera 22 of the Sensicam Vision type (manufacturer: Photonics).

The field forming device 30 contains a high-frequency generator 31 and a switching device 32. Both components may be integrated in a common circuit. The high-frequency generator is a voltage source for generating high-frequency electric voltages, typically in the voltage range from 0.1 to 10 Vrms and in the frequency range from 1 kHz to 100 MHz. The output voltage values, phases and frequencies of the voltages generated by the high-frequency generator 31 can preferably be adjusted manually or by means of the control device 40.

In order to manipulate, in particular deform, biological cells by means of negative dielectrophoresis, the frequency of the high-frequency voltage can advantageously be adjusted as a function of the external conductivity in such a way that the membrane of the analyzed cell is fully charged. To this end, the frequency is selected to be much smaller than the reciprocal value of the membrane relaxation time τ_{cm} (f<<fₘ). The membrane relaxation time is linked to the conductivities in accordance with equation (2):

$${f}_{m} = \frac{1}{2 {πτ}_{m}} {τ}_{m} = {ɛ}_{0} {ɛ}_{m} \frac{R}{h} ( \frac{1}{{σ}_{c}} + \frac{1}{2 {σ}_{e}} ) \qquad ( 2 )$$

In this case, the cell can only be elongated in accordance with equation (3):

$${P}_{D} = \frac{9}{2} {ɛ}_{0} {ɛ}_{m} {E}^{2} {cos}^{2} [ Θ ] \frac{R}{h} \qquad ( 3 )$$

At high frequencies f>>fₘ, the cell membrane is capacitively bridged over, so that the cell is either elongated or compressed as a function of the external and internal conductivities (see equation (1), above).

The high-frequency generator 31 is designed to generate voltage gradients in a manner corresponding to different operating modes of the measuring apparatus, which are illustrated below by way of example. A first operating mode is the holding or trapping mode, in which the object O (e.g. the biological cell) is held in the potential minimum of the dielectric field cage generated by the cage electrodes 1-4. Despite the flowing suspension fluid (arrow A), the cell O is in the resting state. The control protocol for the cage electrodes (voltages, frequencies, phases) are known per se from fluidic microsystem technology. In the second operating mode, namely the deformation mode, voltages are generated such that directional deformation forces are exerted on the held cell O (see below), the fluid flow being stopped in this state.

By means of the schematically shown switching device 32, the presently desired operating mode is selected in which the respective electrodes are acted upon by the desired voltage. The switching device 32 may comprise a changeover switch or a phase shifter and/or may be integrated in the control system of the high-frequency generator 31. In both variants, actuation by means of the control device 40 may be provided.

Reference 50 denotes a fluidic device, by means of which the suspension fluid and/or treatment fluid is moved in the channel 12 of the fluidic microsystem 10. The fluidic device 50 comprises for example a pump which can optionally be actuated by means of the control device 40.

FIG. 2 shows the cage electrodes 1-4, 1′-4′ in an enlarged perspective view. The lower four electrodes 1′-4′ are arranged on the bottom 13 of the fluidic microsystem 10, whereas the electrodes 1-4 are arranged on the top face (not shown). The channel direction corresponds to the flow direction A of the suspension fluid. When the cage electrodes are acted upon by high-frequency electric voltages in a manner corresponding to one of the activation types “trap rot” “trap ac I” or “trap ac II” shown in the following table, a dielectric field cage is formed with a punctiform potential minimum in the centre between the ends of the electrodes, at which the cell to be analyzed is located.

| | Electrode | | | | | | | |
|---|---|---|---|---|---|---|---|---|
| Mode | 1 | 2 | 3 | 4 | 1′ | 2′ | 3′ | 4′ |
| trap rot | 0° | 90° | 180° | 270° | 180° | 270° | 90° | 180° |
| trap ac I | 0° | 180° | 0° | 180° | 180° | 0° | 180° | 0° |
| trap ac II | 0° | 180° | 0° | 180° | 0° | 180° | 0° | 180° |
| stretch ac I | 0° | 0° | 180° | 180° | 0° | 0° | 180° | 180° |
| stretch ac II | 0° | 0° | 0° | 0° | 180° | 180° | 180° | 180° |
| stretch ac III | 0° | ground | 180° | ground | 0° | ground | 180° | ground |
| trap-stretch | F₁/0° | F₂/0° | F₁/180° | F₂/180° | F₁/0° | F₂/180° | F₁/180° | F₂/0° |

The activation type “trap rot” serves to trap the cells in the field cage and to rotate the cell into a predefined orientation relative to the surrounding microsystem. Advantageously, deformations in certain directions can be analyzed in this case. The activation types “trap ac I” and “trap ac II” serve to trap the cell in the field cage without any specific orientation. By switching the relative phase position between the high-frequency voltages on the cage electrodes in a manner corresponding to the activation types “stretch ac I” or “stretch ac II”, a changeover takes place from the trapping mode to the deformation mode. By virtue of the polarization of the cells to be analyzed, deformation forces are formed parallel to the flow direction in the activation types specified by way of example, so that the cell deforms (see FIG. 5). Another stretching mode “stretch ac III” generates a deformation field in an octode cage comprising two opposite electrode pairs, wherein the other electrodes are at ground. Moreover, a “trap-stretch” mode is provided, which demonstrates how, via different electrodes, a particle can be deformed at a frequency F1 and at the same time can be focused dielectrically in the direction weakened by the deformation field at a different frequency F2. The use of this type of activation in connection with an electrode field cage comprising twelve or more electrodes is particularly advantageous, as shown by way of example in FIG. 7C. Here, the deformation by means of the narrow, central two electrode pairs can take place for example with simultaneous dielectric focusing of the particle by means of the outer electrodes of the remaining octode cage.

FIG. 3A shows cage electrodes 1, 2, 1′ and 2′, which are designed to form a dielectric field cage which is open in the flow direction A. The following table accordingly shows the activation types for the trapping mode “trap ac”, in which the cells are focused in the centre of the channel, and the deformation mode “stretch ac I” or “stretch ac II”.

Electrode

| Mode | 1 | 2 | 1′ | 2′ |
|---|---|---|---|---|
| trap ac | 0° | 180° | 180° | 0° |
| stretch ac I | 180° | 0° | 180° | 0° |
| stretch ac II | 180° | 180° | 0° | 0° |

FIGS. 3B and 3C show the electric potentials for the “trap ac” mode (FIG. 3B) and for the “stretch ac I” mode (FIG. 3C) for the cage electrode arrangement of FIG. 3A. FIGS. 3B and 3C show a sectional view of the channel with the electrodes shown in section, wherein the flow direction of the channel is perpendicular to the plane of the drawing. In FIG. 3B, the centrally held cell with polarization charges is shown for the “trap ac I” mode. It can clearly be seen that cells can be deformed easier in this electrode arrangement even without stretching fields than in the eight-electrode cage, since no forces act on the cell in the direction perpendicular to the plane, that is to say in the flow direction. Advantageously, further homogenization of the stretching field (FIG. 3C) can be achieved by means of additional electrodes which are arranged in the plane between the existing electrodes.

FIG. 4 schematically shows the sequence of steps for carrying out the method according to the invention. Following a lining-up operation (step 100), in which a sample comprising a large number of cells is dielectrically lined up in a manner known per se upstream of the analysis area 11, the positioning of a particle in the dielectric field cage of the cage electrodes takes place in step 200 as shown, for example, in FIG. 2. Then, by changing the electrode control, cell deformation takes place (step 300), wherein the deformation (step 400) or the relaxation (step 500) is electrically or optically detected while the deformation forces are being exerted and/or after the deformation forces have been switched off. Thereafter or at the same time (online), the evaluation and quantitative analysis of the deformation takes place in step 600. Depending on the result of step 600, it may be provided that a further deformation with associated detection is carried out. Before the further deformation, a rotation of the object may optionally be provided in step 200. Finally, in step 700, the decision is made as to whether another object is to be analyzed or whether the measurement is to be terminated. Optionally, in step 800, the object is deposited in a suitable container or on a substrate, e.g. into a microtitre plate.

FIG. 5 shows by way of example the deformation of an erythrocyte in a field cage by switching from the trapping mode to the deformation mode. The analysis area has a diameter of around 40 μm. The frequency of the positioning and deformation fields is 700 kHz (3 Vᵣₘₛ) The conductivity of the suspension fluid is 0.3 S/m. FIGS. 5A and B show microscope images of the erythrocyte O in the trapping and deformation mode. Figs. 5C to D illustrate the field distribution in the horizontal central plane of the electrode arrangement according to FIG. 2 in the trapping mode for the activation protocol “trap rot” or “trap ac II”. The courses of the time-averaged values of the square of the electric field (E²) in the central horizontal plane between the electrodes at a given point in time are shown in each case as lines of equal potential. The polarization forces acting on the object are proportional to the variable E². FIG. 5E shows the course of E² in the stretching mode. Fig. 5F shows the electric potential f in the stretching mode when implementing activation type “stretch ac I”.

As can be seen from the field simulations, a cell which was initially trapped centrally in the cage (FIG. 5A, zero field) is located in a strong, relatively homogeneous (saddle-shaped) electric field when a changeover is made to the stretching mode. Without external interference, the cell remains in the central area, where it is deformed (FIG. 5B). It has been found by way of experiments that, with well-balanced fluidics, the cell remains in the central area for up to a few seconds, wherein the relaxation can be observed after the changeover or switching-off operation.

These analyses can be carried out in parallel during flow (see FIG. 3) and optionally on a number of cells lined up for example via funnel-shaped field barriers (by means of “funnel electrodes” or so-called funnels).

When measuring the deformation and/or relaxation (steps 400, 500 ), images of the object O which have been recorded by the detector device 20 are measured for example. By way of example, the object diameter before and during the deformation is detected. In order to determine relaxation times, a corresponding time dependence is recorded. If, by way of example, a spherical cell is deformed into an ellipsoid shape, a measurement of the semi-axes of the ellipsoid takes place. From the measured geometric values and/or the determined time function, the desired elastic properties are determined as a function of the model used.

In a manner differing from the procedure described above by way of example, the following modifications may be provided when implementing the invention.

A parameter optimization may be provided, for example in order to keep the object O in the centre of the analysis area in the best possible way. To this end, control signals are derived from the image data of the detector device, and these control signals are used to adjust the parameters of the output voltages of the high-frequency generator until the desired centring is obtained. A corresponding control loop may be designed to alter the field strength or frequency of the deformation fields in order to achieve a certain deformation result. It is possible for field-strength-dependent and/or frequency-dependent deformation measurements to be carried out.

As an alternative or in addition to the above-described stretching mode in the horizontal plane, a deformation in a different direction, e.g. in the vertical plane, can be carried out. Furthermore, a targeted stretching of the object O in the field cage to form a needle shape may be provided.

In order to optimize the positioning or deformation fields, the frequencies thereof may differ. The deformation fields may be generated at the same time as a permanently formed positioning field. In accordance with equation (1), elongating or compressive fields may be formed.

In general, it is possible to introduce both the trapping field and the stretching field simultaneously rather than alternately (for example the “trap-stretch” mode). This may advantageously take place, for example, by operating the trapping field and the stretching field at different frequencies.

Instead of the eight-electrode or four-electrode field cages, other electrode geometries may be formed, as known per se from fluidic microsystem technology. It is possible for example for six-pole electrode arrangements to be formed.

Moreover, it may be advantageous to use multiple electrode arrangements, in particular electrode arrangements comprising twelve electrodes, in order to generate homogeneous stretching fields with a virtually unaltered trapping field. FIG. 7 shows the square of the averaged field strength E² in the horizontal plane between the electrodes. FIGS. 7A and 7B show electrode arrangements, which correspond to those described above in connection with FIGS. 5A to 5F. The arrow shows the flow direction of the channel. FIGS. 7C and 7D show electrode arrangements with a total of twelve electrodes, only the upper six electrodes of which are shown. Preferably, the additional electrodes are fitted centrally on a plane between the eight electrodes, wherein the additional electrodes intersect the channel perpendicular to the flow direction. By virtue of the additional electrodes, in the stretching mode the field is more homogeneous close to the trapping spot, so that a particle arranged at that spot is subjected to smaller dielectrophoretic forces (see FIGS. 7C and 7D). Specifically when the flow in the channel direction has not fully come to a rest, the central additional electrodes may be particularly advantageous since they focus in the flow direction. Activation can be achieved in a particularly simple manner in the “stretch ac I” mode since no additional phases are required. The additional electrodes are switched to either 0° or 180° depending on the two adjacent electrodes in each case.

Both in the case of eight electrodes and in the case of twelve electrodes, a saddle is obtained in the centre of the trapping field in the “stretch ac I” mode (see FIGS. 7B and 7D). In order to prevent this, it may be advantageous if the outer boundaries of the electrode tips of the obliquely arranged electrodes run parallel to one another, as shown in FIGS. 7E and 7F. In FIGS. 7E and 7F, the parallel-running outer limits of the electrode tips are shown in connection with a twelve-electrode arrangement. The parallel-running outer boundaries of the electrode tips can however also be used with advantage in the case of an eight-electrode arrangement, as shown in FIGS. 7A and 7B. In general, parallel-running outer boundaries of the electrode tips are suitable for generating more homogeneous stretching fields. The improved homogeneous stretching field in the case of the parallel-running outer boundaries of the electrode tips is shown in FIG. 7F for the “stretch ac I” mode. Another possibility for achieving greater homogeneity is for the electrodes not to be arranged equidistantly (not shown).

The features of the invention which are disclosed in the above description, the drawings and the claims may be important both individually and in combination for implementing the invention in its various embodiments.

1-34. (canceled)

35. A method for analyzing at least one deformable object in a suspension fluid, comprising the steps of:
generation of an electric positioning field and positioning of the object in a potential minimum of the positioning field;
generation of an electric deformation field so as to exert a deformation force on the object; and
detection of at least one property selected from the group consisting of dielectric, geometric and optical properties of the object,
wherein the positioning field is generated in a compartment of a fluidic microsystem, and the positioning of the object takes place in a contactless manner without electrode contact or in a freely suspended state.

36. The method according to claim 35, wherein the positioning of the object takes place under an effect of negative dielectrophoresis or under an effect of positive dielectrophoresis.

37. The method according to claim 35, wherein the generation of the deformation force takes place under an effect of negative dielectrophoresis or under an effect of positive dielectrophoresis.

38. The method according to claim 35, wherein the detection takes place during or after the deformation of the object and accordingly comprises a determination of deformation or relaxation properties of the object.

39. The method according to claim 35, wherein the positioning field is generated as a high-frequency field cage by a cage electrode arrangement.

40. The method according to claim 39, wherein the high-frequency field cage is operated as a closed field cage with a punctiform potential minimum, in which the object rests.

41. The method according to claim 39, wherein the high-frequency field cage is operated as an open field cage with a linear potential minimum, through which the object moves with the suspension fluid.

42. The method according to claim 39, wherein the cage electrode arrangement is used to generate the deformation field.

43. The method according to claim 39, wherein a separate deformation electrode arrangement is used to generate the deformation field.

44. The method according to claim 35, wherein the deformation field is set for a duration of 1 ms to 500 ms.

45. The method according to claim 35, wherein the generation of the deformation field takes place in a pulsed manner.

46. The method according to claim 35, wherein the object is exposed to a treatment fluid before or during the generation of the deformation field.

47. The method according to claim 35, further comprising a multiple measurement in which the steps of generation of the deformation field with the detection and the generation of the positioning field are carried out in an alternating manner a number of times one after the other.

48. The method according to claim 47, wherein the multiple measurement is carried out for a duration of at least one second.

49. The method according to claim 47, wherein at least one of the positioning field and the deformation field is adjusted or changed as a function of a result of the respectively preceding detection.

50. The method according to claim 47, wherein at least one of the deformation field and the positioning field is adjusted a number of times in such a way that the object is in each case deformed in different directions.

51. The method according to claim 35, wherein viscoelastic properties of the object are determined from the detected dielectric, geometric or optical properties.

52. The method according to claim 35, wherein, prior to the positioning step, the object is selected from a sample which has been subjected to a dielectric lining-up operation.

53. The method according to claim 35, wherein the object comprises at least one biological cell, cell group, cell constituent or synthetic particle.

54. The method according to claim 53, wherein a distinction is made between normal and altered cells or between normal cells having different physiological properties as a function of the detected dielectric, geometric and/or optical properties.

55. The method according to claim 53, wherein stem cells are identified as a function of the detected dielectric, geometric and/or optical properties.

56. The method according to claim 53, wherein the dielectric, geometric or optical properties of the cell are detected as a function of at least one of the following parameters:
frequency of the positioning field,
frequency of the deformation field,
voltage of the positioning field,
voltage of the deformation field,
temperature of the suspension or treatment fluids,
material composition of the suspension or treatment fluids,
duration of the individual deformation, and
duration of a number of deformations.

57. The method according to claim 53, wherein a measurement of cell pairs or cell aggregates and/or a separation of cell pairs takes place.

58. The method according to claim 57, wherein the cell pairs or cell aggregates are brought together in the positioning field.

59. A measuring apparatus for analyzing at least one object, said measuring apparatus comprising:
a fluidic microsystem having a compartment containing at least one electrode arrangement;
a detector device adapted to measure electric, geometric and/or optical properties of the object; and
a field forming device comprising at least one high-frequency generator, wherein the field forming device can be switched between an operating state in which a high-frequency positioning field is generated in the compartment by the at least one electrode arrangement and an operating state in which a deformation field is generated in an analysis area by the at least one electrode arrangement.

60. The measuring apparatus according to claim 59, wherein the field forming device contains a switching device adapted to switch between the operating states.

61. The measuring apparatus according to claim 59, wherein the detector device includes a microscope with a camera.

62. The measuring apparatus according to claim 59, wherein the fluidic microsystem is equipped with a fluidic device for moving at least one of a suspension fluid and a treatment fluid through the analysis area.

63. The measuring apparatus according to claim 59, wherein a control device is provided which is connected to the detector device and the switching device.

64. The measuring apparatus according to claim 63, wherein the control device forms a control loop in which the positioning field and/or the deformation field can be adjusted or changed as a function of a result of the preceding detection.

65. The measuring apparatus according to claim 59, wherein the electrode arrangement comprises electrodes with electrode tips, wherein the electrode tips of neighboring electrodes have boundaries running parallel at least in some sections.

66. The measuring apparatus according to claim 65, wherein the boundaries are oriented parallel or perpendicular to a longitudinal direction of the compartment of the fluidic micro system.

67. The measuring apparatus according to claim 59, wherein the positioning field and the deformation field are switched on at the same time in the second operating state.

68. A method of analyzing biological cells, said method comprising using a fluidic microsystem with a high-frequency field cage to analyze at least one of deformation and relaxation properties of the biological cells.
